(19) United States
(12) Patent Application Publication
(10) Pub. No.: US 2014/0040369 A1
(43) Pub. Date: Feb. 6, 2014

(54) Systems and Methods for Providing a Cue When a Participant Joins a Conference

(71) Applicants: Boland T. Jones, Atlanta, GA (US); David Michael Guthrie, Norcross, GA (US)

(72) Inventors: Boland T. Jones, Atlanta, GA (US); David Michael Guthrie, Norcross, GA (US)

(73) Assignee: AMERICAN TELECONFERENCING SERVICES, LTD., Atlanta, GA (US)

(21) Appl. No.: 13/823,019

(22) PCT Filed: Oct. 29, 2011
(86) PCT No.: PCT/US11/58490

§ 371 Date: Mar. 13, 2013

(30) Foreign Application Priority Data
Apr. 29, 2011 (US) PCT/US2001/034472
Apr. 29, 2011 (US) PCT/US2011/034421
Apr. 29, 2011 (US) PCT/US2011/034438

(51) Int. Cl. H04L 29/06

(52) U.S. Cl. CPC H04L 65/403
USPC 709/204

(57) ABSTRACT

A method for providing a cue when a nonparticipant joins a conference includes identifying received data indicating that a particular nonparticipant has joined the conference, searching a cue store for information associated with the particular nonparticipant, and publishing a cue responsive to the information associated with the nonparticipant. A conferencing system includes client devices with respective display devices, a conference host computer coupled to the client devices via one or more networks, the conference host computer operating a web server, and a cue store coupled to the host computer. The cue store includes at least one cue element identified by a nonparticipant privileged to join the conference, the cue element including information designated for publication by the web server to one or more client devices connected to the conference.

### CROSS-REFERENCE TO RELATED APPLICATIONS

This application is a continuation-in-part patent application of U.S. patent application Ser. No. 12/771,979, entitled “Conferencing Alerts” (First Named Inventor: Boland Jones; Attorney Docket No. 16003.1202U1) and filed on Apr. 30, 2010, which is hereby incorporated by reference in its entirety. This application is related by subject matter to U.S. patent application Ser. No. 13/078,132, entitled “Systems, Methods, And Computer Programs For Monitoring a Conference And Communicating With Participants Without Joining As a Participant;” First Named Inventor: David Michael Guthrie; Attorney Docket No. 16003.1233U1) and filed on Apr. 1, 2011, which is hereby incorporated by reference in its entirety.

### BACKGROUND

Currently, there are a number of conference solutions for enabling people to conduct live meetings, conferences, presentations, or other types of gatherings via the Internet, the public switched telephone network (PSTN), or other voice and/or data networks. Participants typically use a telephone, computer, or other communication device that connects to a conference system. The meetings include an audio component and a visual component, such as, a shared presentation, video, whiteboard, or other media to communicate with one another. These conference solutions have become an indispensable form of communication for many businesses and individuals.

Despite the many advantages and commercial success of existing conference, meeting, grouping or other types of gathering systems, there remains a need in the art for improved conference, meeting, grouping or other types of gathering systems, methods, and computer programs.

### SUMMARY

Various embodiments of a conferencing system and a method for providing a cue when a new participant joins a conference are disclosed. One embodiment is a conferencing system that publishes or executes a cue when an identified nonparticipant has joined the conference. The conferencing system includes client devices, a conferencing host computer, and a cue store. The client devices are associated with respective display devices. The client devices are coupled to the conferencing host computer via one or more networks. The cue store is coupled to the conferencing host computer and includes at least one cue element identified by a nonparticipant privileged to join the conference. The cue element includes information designated for publication by the web server to one or more client devices connected to the conference.

Another embodiment is a method for providing a cue when a new participant joins a conference. The method includes identifying, at a conference host computer, received data indicating that a particular nonparticipant has joined a conference, searching, a cue store, for information associated with the particular nonparticipant and publishing, in a web server, a cue responsive to the information associated with the particular nonparticipant.

### BRIEF DESCRIPTION OF THE DRAWINGS

FIG. 1 is a block diagram illustrating an embodiment of a conferencing system for providing a cue when a conference participant joins a conference.

FIG. 2 is a block diagram illustrating an embodiment of a cue configuration interface for accessing exemplary services provided by the conferencing notification application of FIG. 1.

FIG. 3 is a block diagram illustrating an embodiment of a graphical user interface (GUI) operable on a computing device coupled to the conference host computer of FIG. 1.

FIG. 4 is a flow diagram illustrating an embodiment of a method for providing a cue when a conference participant joins a conference.

FIG. 5 is a flow diagram illustrating an alternative embodiment of a method for providing a cue when a conference participant joins a conference.

### DETAILED DESCRIPTION

Various embodiments of systems and methods are disclosed for providing a cue when a conference participant joins a conference. The conference joined by the nonparticipant may comprise any online conference, meeting, grouping, or other types of gatherings (collectively, a “conference”, with a system that provides the conference being referred to as a “conferencing system”) for any variety of purposes of one or more people, groups or organizations (including combinations thereof and collectively referred to as “participants”) with or without an audio component, including, without limitation, enabling simulcast audio with such conference for the participants. Exemplary embodiments of the conference and a conferencing system and related features may be implemented as described in the parent patent application, U.S. patent application Ser. No. 12/771,979, the entire contents of which are hereby incorporated by reference into this specification. Additional exemplary embodiments of the conference and a conferencing system that supports the conference and related features are further described in U.S. patent application Ser. No. 13/078,132, the entire contents of which are also incorporated herein by reference.

A user or subscriber to the conferencing system accesses a cue configuration interface operable on a conference host computer. The user or subscriber uses the cue configuration interface to communicate information to a cue store. The cue information is associated with an identified subscriber to the conferencing service and published to a web server when the subscriber, a nonparticipant to a conference, joins the conference. The information in the cue store can include text, an icon, an image, an audio segment, or a video segment. A video segment may include video information or a combination of audio and video information. The user or subscriber also uses the cue configuration to modify one or more characteristics of a select element communicated or published by the web server to one or more participants of the conference via their respective client devices. The configurable cue characteristics include one or more of location in a conference user interface, color, size, font and/or the variation of one or more of these over time as may be desired. The configurable cue characteristics also include the manipulation for a relatively brief time of a conference participant cube in the conference user interface.

The cue configuration interface further enables the communication by a user or subscriber to the conferencing system of one or more conference conditions. The existence or absence of the one or more conference conditions, as indicated by the user, is identified and used to direct the publication of the cue information and any modified characteristics thereof to one or more conference participants.

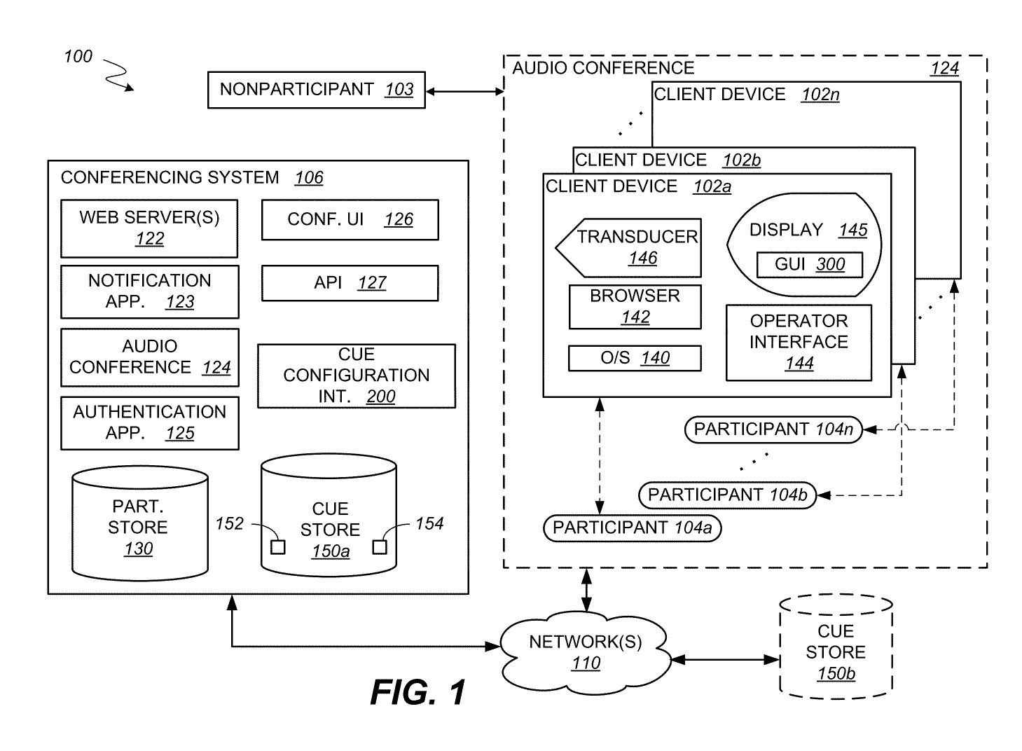

FIG. 1 illustrates a conferencing environment 100 representing an exemplary working environment for enabling a nonparticipant 103 to join an audio conference 124. The nonparticipant 103 is a registered subscriber of a conference service provided by the conferencing system 106. The audio conference 124 comprises client devices 102 in communication with a conferencing system 106 and web server(s) 122 via one or more communication networks 110. The network(s) 110 may support wired and/or wireless communication via any suitable protocols, including, for example, the Internet, the Public Switched Telephone Network (PSTN), cellular or mobile network(s), local area network(s), wide area network(s), or any other suitable communication infrastructure. The conferencing system 106 establishes a conference (e.g., an audio conference 124) between client devices 102 associated with participant 104a and participant 104b. The audio conference 124 may have a corresponding online component presented to participant 104a and participant 104b via a conference user interface 126. In an embodiment, the conference user interface 126 may be configured in any of the ways described in the above-referenced parent patent application, or others, to provide a visually engaging conference experience via the browser 142 to participants 104. When the client device 102 is arranged with an integrated transducer 146 or coupled to an external transducer or transducers, the conference user interface 126 can produce sound at designated times such as when a nonparticipant 103 joins the audio conference 124.

In contrast to the participant 104a and the participant 104b, the client device 102n associated with the nonparticipant 103 is at least initially not connected to the conference user interface 126 or audio conference 124 as a participant. The nonparticipant 103 may be a scheduled host or a scheduled participant who has not yet joined the conference or another individual or group of individuals who wishes to join the conference. The terms “host” and “participant” merely refer to different user roles or permissions associated with subscribers of the conferencing service provided by the conferencing system 106. For example, the “host” may be the originator of the conference and, consequently, may have privileges that are not offered to the remaining participants. Nonetheless, it should be appreciated that the terms “host,” “participant,” and “user” may be used interchangeably depending on the context in which it is being used and that the term “nonparticipant” merely refers to a subscriber or user that is not initially connected to the conference via conferencing system 106.

The client devices 102 may comprise any desirable client device, which is configured to communicate with the conferencing system 106 and the web server(s) 122 via the networks 110. The client device 102 may comprise, for example, a personal computer, a desktop computer, a laptop computer, a mobile client device, a portable computing device, a smart phone, a cellular telephone, a landline telephone, a soft phone, a web-enabled electronic book reader, a tablet computer, or any other client device 102 capable of communicating with the conferencing system 106 and/or the web server(s) 122 via one or more networks 110. The client device 102 may include a display device 145, a processor, memory, and software, including an operating system 140, a graphical user interface 300, and client software (e.g., a browser 142, plug-in, or other functionality) configured to facilitate communication with the conferencing system 106 and the web server(s) 122. It should be appreciated that the hardware, software, and any other performance specifications of the client device 102 are not critical and may be configured according to the particular context in which the client device 102 is to be used. In this regard, the client device 102 may include one or more transducers 146 for reproducing one or more an audio signals as well as an operator interface 144 for receiving inputs from an operator of the client device 102. Further in this regard, the operator interface 144 may include one or more of a touch sensitive screen, a keyboard, a microphone, a thumb wheel or other human-machine interface that functions in conjunction with the GUI 300.

The conferencing system 106 generally comprises a communication system for establishing an audio conference 124 between the client devices 102. The conferencing system 106 may support audio via a voice network and/or a data network. In one of a number of possible embodiments, the conferencing system 106 may be configured to support, among other platforms, a Voice over Internet Protocol (VoIP) conferencing platform such as described in U.S. patent application Ser. No. 11/637,291 entitled “VoIP Conferencing,” filed on Dec. 12, 2006, which is hereby incorporated by reference in its entirety. It should be appreciated that the conferencing system 106 may support various alternative platforms, technologies, protocols, standards, features, etc. Regardless of the communication infrastructure, the conferencing system 106 may be configured to establish a data and/or audio connection with the client devices 102. In the case of nonparticipants 103, the connection may be a data connection, while in the case of participants 104 the connection may be an audio connection, although in some embodiments the audio portion may be removed. The conferencing system 106 may establish the audio conference 124 by combining audio streams associated with the participant client devices 102.

The conferencing system 106 includes web server(s) 122, a notification application 123, an authentication application 125, the conference user interface 126, an application programming interface (API) 127 and a cue configuration interface 200. The web server(s) 122 are computers, virtual machines, or computer operated programs that publish information from the conference user interface 126 to coupled client devices 102 using the Hypertext Transfer Protocol (HTTP), over the networks 110.

The authentication application 125 is a computer operated program that is arranged to confirm the identity of a possible conference participant such as the nonparticipant 103 before connecting the client device 102n associated with the nonparticipant 103 to the audio conference 124 and before exposing the conference user interface 126 via a browser 142 and display 145 to the nonparticipant 103. The authentication application 125 can be arranged to employ any number of queries or information exchanges with the nonparticipant 103 in an effort to confirm the identity of the nonparticipant as a subscriber to the conferencing service provided by the conferencing system 106.

The authentication application 125 is arranged to communicate with participant store 130 to complete the nonparticipant authentication. The participant store 130 contains the names and/or usernames and access codes for subscribers of the conferencing service supported by the conferencing system 106. In some embodiments the participant store 130 contains additional information that can be used to confirm the identity of subscribers to the conferencing service. This additional information can include images, questions associated with answers entered by an identified subscriber, among other information not commonly known by those other than the subscriber.

The notification application 123 is a computer operated program that is arranged to identify when certain condition(s) are present in the audio conference 124. For example, the notification application 123 is arranged to forward a notice to the conference user interface 126 when nonparticipant 103 has requested to join the audio conference 124. The notice directs the conference user interface 126 to apply or otherwise engage the authentication application 125 to ensure that the nonparticipant 103 is a registered user of the conferencing system 106 before connecting the nonparticipant's client device 102 to the conference. In addition, the notification application 123 can be arranged to provide participant and conference specific information to the conference user interface 126. Participant and conference specific information may include the identity of the moderator or host of the conference, the subject or title of the conference, a designated start and end time for the conference, a list of those invited to attend, a list of actual attendees, the number of attendees presently connected to the conference, information identifying a present speaker, among other information. The notification application 123 may communicate the occurrence of an event (e.g., that a nonparticipant(s) 103 has joined the conference and transitioned to a conference participant 104) by publishing cue information from a cue store 150. Cue information may comprise audio, video, text, graphics, or other information associated with a specified nonparticipant subscriber to the conferencing service. Cue information 152 includes information configured by the nonparticipant 103 via the cue configuration interface 200. Cue information 154 includes information configured by a moderator or a conferencing system administrator using the cue configuration interface 200.

However created and arranged in the cue store 150, the conference user interface 126, in response to a notice that an identified (e.g., authenticated) nonparticipant 103 has joined the audio conference 124, retrieves cue information associated with the identified nonparticipant 103 from the cue store 150 and publishes or executes the same via the web server(s) 122. In accordance with the nature of the cue information and the capabilities of the client device 102, the cue information is embodied on a client device 102 associated with a participant 104. The cue information may be implemented using a push methodology by which the cue information are “pushed” from the conferencing system 106, a pull methodology by which the cue information are “pulled” from the conferencing system 106 by the client device 102 using, for example, the conferencing API 127, or other communication protocols, services, methodologies, etc. The cue information can be presented by hardware and/or software components supported by the client device 102, including, the browser 142, operating system 140, transducer(s) 146 (including speakers and/or vibrators) and the display 145. When the cue information is presented with the display 145, the cue information 152, 154 is presented in the GUI 300.

As nonparticipants 103 join the audio conference 124 or the associated data conference via the conferencing user interface and their browser 142, the conference user interface 126 by way of the web server(s) 122 alerts or informs one or more of the participants 104 of the newly added participant 104 (formerly nonparticipant 103) by presenting the cue information 152, 154 on the respective client device 102. The cue information appears for a pre-determined amount of time, which may be configurable in the cue configuration interface 200 by a moderator or by the participant 104n being introduced or the participant 104a being notified of the new participant via the cue information. The cue information may include text, an icon, an image, an audio segment, or a video segment. In addition to the content and the nature of the cue information 152, 154, one or more characteristics of a select cue element can be controllably modified. For example, when the cue information includes a text string, the size, font type, and color of the text can be modified. Furthermore, a subscriber to the conferencing service can instruct the conference user interface 126 as to how long the text message is to be displayed and whether the message should be scrolled across the GUI 300 of the client device 102. When the cue information includes an image or icon, the size, color(s), contrast, hue, or brightness of the same can be modified.

In addition, as nonparticipants 103 join the audio conference 124 or the associated data conference via the conferencing user interface and their browser 142, the conferencing system 106 maintains a log or count of the number and identity of participants 104 and provides related or other information to the host. The notification application 123, the cue configuration interface 200, and/or the API 127 may enable the host to conveniently access the conference interface 126 from within the application (e.g., via a menu, shortcut, or other user interface control), as well as modify conferencing, notification or account settings prior to or during a virtual conference.

To implement the cue and cue characteristics on a client device 102 coupled to the conferencing system 106, the conferencing system 106 may support various web services for exchanging structured information with the browser 142 or other elements on the client device 102. The web services may be implemented using any suitable protocol. In one embodiment, the web services may be implemented via a Representation State Transfer (REST) architecture or system. In alternative embodiments, the web services may be implemented via the Simple Object Access Protocol (SOAP) using Extensible Markup Language (XML) as the messaging format. The conferencing system 106 may respond to web service calls from one or more of the notification application 123, the authentication application 125, and the cue configuration interface 200 by either returning the requested information immediately or by initiating the request and then providing the results (later) via a polling action. One of ordinary skill in the art will appreciate that any suitable methodology may be used to exchange data between the various applications and configuration modules and the conference system 106. For example, the data may be exchanged in real-time, near real-time, using push and/or pull notifications, or any combination thereof, any of which may be customized by the user.

Various exemplary web services for implementing one or more aspects of the systems and methods for presenting a cue when a nonparticipant joins a conference are provided. The web services may comprise any of the following, or other, web services: a subscribe/unsubscribe service; a conference notification service; a conferencing polling service; an authentication service; a conference schedule service; and a join conference service. Each of these web services are generally described below with reference to exemplary request and response XML messages.

The subscribe/unsubscribe service may be implemented with a Subscribe( )call that establishes authorization to use the resources provided by the conferencing system 106. The Subscribe( )call may be the first call made by a potential subscriber to the conferencing system 106. In an embodiment, the Subscribe( )call may require an authorization response before the conferencing system 106 may access or otherwise expose other services. In this regard, the subscribe/unsubscribe service may be configured without a security token in the SOAP header. The other web services may be implemented with the security token (e.g., a session ID obtained with the Subscribe( ) call).

An exemplary XML request for the Subscribe( )call may be configured as follows:

<?xml version=“1.0” encoding=“utf-8”?>
<soap:Envelope
xmlns:xsi=“http://www.w3.org/2001/XMLSchema-instance”
xmlns:xsd=“http://www.w3.org/2001/XMLSchema” xmlns:soap=“http://
schemas.xmlsoap.org/soap/envelope/”>
<soap:Body>
<Subscribe xmlns=“http://pia.premiereglobal.com/”>
<ClientID>string</ClientID> <ClientPW>string</ClientPW>
<WebID>string</WebID>
<WebPW>string</WebPW>
</Subscribe>
</soap:Body>
</soap:Envelope>

An exemplary XML response for the Subscribe() call may be configured as follows:

<?xml version=“1.0” encoding=“utf-8”?>
<soap:Envelope
xmlns:xsi=“http://www.w3.org/2001/XMLSchema-instance”
xmlns:xsd=“http://www.w3.org/2001/XMLSchema” xmlns:soap=“http://
schemas.xmlsoap.org/soap/envelope/”>
<soap:Body>
<SubscribeResponse xmlns=“http://pia.premiereglobal.com/”>
<SubscribeResult>
<ResultCode>ResultCode</ResultCode>
<SessionID>string</SessionID>
</SubscribeResult>
</SubscribeResponse>
</soap:Body>
</soap:Envelope>

An Unsubscribe( )call may be made to unsubscribe the user from the web services when subscriber is disconnected from the conference system 106. The call may terminate the session with the conferencing system 106. Further interactions with the conferencing system 106 may require a subsequent Subscribe() call to be made by the conferencing notification application.

An exemplary XML request for the Unsubscribe() call may be configured as follows:

<?xml version=“1.0” encoding=“utf-8”?>
<soap:Envelope
xmlns:xsi=“http://www.w3.org/2001/XMLSchema-instance”
xmlns:xsd=“http://www.w3.org/2001/XMLSchema” xmlns:soap=“http://
schemas.xmlsoap.org/soap/envelope/”>
<soap:Header>
<SoapSecurityHeader xmlns=“http://pia.premiereglobal.com/”>
<SessionID>string</SessionID>
</SoapSecurityHeader>
</soap:Header>
<soap:Body>
<Unsubscribe xmlns=“http://pia.premiereglobal.com/” />
</soap:Body>
</soap:Envelope>

An exemplary XML response for the Unsubscribe() call may be configured as follows:

<?xml version=“1.0” encoding=“utf-8”?>
<soap:Envelope xmlns:xsi=http://www.w3.org/2001/XMLSchema-instance
xmlns:xsd=“http://www.w3.org/2001/XMLSchema” xmlns:soap=“http://
schemas.xmlsoap.org/soap/envelope/”>
<soap:Body>
<UnsubscribeResponse xmlns=“http://pia.premiereglobal.com/”>
<UnsubscribeResult>
<ResultCode>ResultCode</ResultCode>
</UnsubscribeResult>
</UnsubscribeResponse>
</soap:Body>
</soap:Envelope>

The conference notification service may invoke a SetConferenceWatch() call that establishes a conference watch, which enables the conferencing system 106 to begin sending alerts to the notification application 123. After setting a conference watch, the conference user interface 126 may receive notifications or alerts for conference(s) associated with the user, including, for example, when a participant 104 joins or leaves a conference, when a participant speaks during an audio conference 124, when a participant posts or receives information associated with a social networking system, etc.

An exemplary XML request for the SetConferenceWatch() call may be configured as follows:

<?xml version=“1.0” encoding=“utf-8”?>
<soap:Envelope
xmlns:xsi=“http://www.w3.org/2001/XMLSchema-instance”
xmlns:xsd=“http://www.w3.org/2001/XMLSchema” xmlns:soap=“http://
schemas.xmlsoap.org/soap/envelope/”>
<soap:Header>
<SoapSecurityHeader xmlns=“http://pia.premiereglobal.com/”>
<SessionID>string</SessionID>
</SoapSecurityHeader>
</soap:Header>
<soap:Body>
<SetConferenceWatch xmlns=“http://pia.premiereglobal.com/”>
<ConferenceID>string</ConferenceID>
</SetConferenceWatch>
</soap:Body>
</soap:Envelope>

An exemplary XML response for the SetConferenceWatch() call may be configured as follows:

<?xml version=“1.0” encoding=“utf-8”?>
<soap:Envelope
xmlns:xsi=“http://www.w3.org/2001/XMLSchema-instance”
xmlns:xsd=“http://www.w3.org/2001/XMLSchema” xmlns:soap=“http://
schemas.xmlsoap.org/soap/envelope/”>
<soap:Body>
<SetConferenceWatchResponse xmlns=“http://pia.premiereglobal.com/”>
<SetConferenceWatchResult>
<ResultCode>ResultCode</ResultCode>
</SetConferenceWatchResult>
</SetConferenceWatchResponse>
</soap:Body>
</soap:Envelope>

The conference watch service may also invoke a ClearConferenceWatch() call that may be used to clear a previously established conference watch. Removing a conference watch may cause the alerts or cue notices for the specified conference to be disabled. After clearing the conference watch, the user will no longer receive cues or other alerts.

An exemplary XML request for the ClearConferenceWatch() call may be configured as follows:

<?xml version=“1.0” encoding=“utf-8”?>
<soap:Envelope
xmlns:xsi=“http://www.w3.org/2001/XMLSchema-instance”
xmlns:xsd=“http://www.w3.org/2001/XMLSchema” xmlns:soap=“http://
schemas.xmlsoap.org/soap/envelope/”>
<soap:Header>
<SoapSecurityHeader xmlns=“http://pia.premiereglobal.com/”>
<SessionID>string</SessionID>
</SoapSecurityHeader>
</soap:Header>
<soap:Body>
<ClearConferenceWatch xmlns=“http://pia.premiereglobal.com/”>
<ConferenceID>string</ConferenceID>
</ClearConferenceWatch>
</soap:Body>
</soap:Envelope>

An exemplary XML response for the ClearConferenceWatch() call may be configured as follows:

<?xml version=“1.0” encoding=“utf-8”?>
<soap:Envelope xmlns:xsi=http://www.w3.org/2001/XMLSchema-instance
xmlns:xsd=“http://www.w3.org/2001/XMLSchema” xmlns:soap=“http://
schemas.xmlsoap.org/soap/envelope/”>
<soap:Body>
<ClearConferenceWatchResponse xmlns=“http://
pia.premiereglobal.com/”>
<ClearConferenceWatchResult>
<ResultCode>ResultCode</ResultCode> </
ClearConferenceWatchResult>
</ClearConferenceWatchResponse>
</soap:Body>
</soap:Envelope>

The conferencing polling service may invoke a PollForMessages() call, which is used to request events from a watched conference. In response to the request, the notification application 123 will receive events associated with the watched conference.

An exemplary XML request for the PollForMessages() call may be configured as follows:

<?xml version=“1.0” encoding=“utf-8”?>
<soap:Envelope
xmlns:xsi=“http://www.w3.org/2001/XMLSchema-instance”
xmlns:xsd=“http://www.w3.org/2001/XMLSchema” xmlns:soap=“http://
schemas.xmlsoap.org/soap/envelope/”>
<soap:Header>
<SoapSecurityHeader xmlns=“http://pia.premiereglobal.com/”>
<SessionID>string</SessionID>
</SoapSecurityHeader>
</soap:Header>
<soap:Body>
<PollForMessages xmlns=“http://pia.premiereglobal.com/” />
</soap:Body>
</soap:Envelope>

An exemplary XML response for the PollForMessages() call may be configured as follows:

<?xml version=“1.0” encoding=“utf-8”?>
<soap:Envelope
xmlns:xsi=“http://www.w3.org/2001/XMLSchema-instance”
xmlns:xsd=“http://www.w3.org/2001/XMLSchema” xmlns:soap=“http://
schemas.xmlsoap.org/soap/envelope/”>
<soap:Body>
<PollForMessagesResponse xmlns=“http://pia.premiereglobal.com/”>
<PollingRequestResult>
<ResultCode>ResultCode</ResultCode>
</PollingRequestResult>
</PollForMessagesResponse>
</soap:Body>
</soap:Envelope>

The authentication service, the conference schedule service, and the join conference service may enable the notification application 123 to interface with a registration system. The authentication service may invoke a SecurityValidateLogOn() call to validate a user's logon credentials. The call may return a security token, which may be used to create a login header. The login header may be sent with one or more of the other service calls. An exemplary XML request for the SecurityValidateLogOn() call may be configured as follows:

```
<?xml version=“1.0” encoding=“utf-8”?>
<soap:Envelope xmlns:xsi=“http://www.w3.org/2001/XMLSchema-
instance” xmlns:xsd=“http://www.w3.org/2001/XMLSchema”
xmlns:soap=“http://schemas.xmlsoap.org/soap/envelope/”>
  <soap:Body>
  <SecurityValidateLogOn xmlns=“Conferencing”>
    <request>
    <LogOnId>string</LogOnId>
    <Password>string</Password>
    <WebId>string</WebId>
    <WebPassword>string</WebPassword>
    </request>
  </SecurityValidateLogOn>
  </soap:Body>
</soap:Envelope>
```

An exemplary XML response for the SecurityValidateLogOn() call may be configured as follows:

```
<?xml version=“1.0” encoding=“utf-8”?>
<soap:Envelope xmlns:xsi=“http://www.w3.org/2001/XMLSchema-
instance” xmlns:xsd=“http://www.w3.org/2001/XMLSchema”
xmlns:soap=“http://schemas.xmlsoap.org/soap/envelope/”>
  <soap:Body>
  <SecurityValidateLogOnResponse xmlns=“Conferencing”>
    <SecurityValidateLogOnResult>
    <Token>guid</Token>
    <TokenExpirationUtc>dateTime</TokenExpirationUtc>
    <FirstName>string</FirstName>
    <LastName>string</LastName>
    <Email>string</Email>
    <ClientId>int</ClientId>
    <IntlClientId>string</IntlClientId>
    <ProviderId>int</ProviderId>
    <ProviderName>string</ProviderName>
    <CompanyId>int</CompanyId>
    <IntlCompanyId>string</IntlCompanyId>
    <CompanyName>string</CompanyName>
    <CorporateCustomerId>int</CorporateCustomerId>
    <CorporateCustomerName>string</CorporateCustomerName>
    <HubId>int</HubId>
    <HubName>string</HubName>
    <HubGroupId>int</HubGroupId>
    <HubGroupName>string</HubGroupName>
    <HubUrls>
      <string>string</string>
      <string>string</string>
    </HubUrls>
    <RedFlagDate>dateTime</RedFlagDate>
    <FinanceChangeDate>dateTime</FinanceChangeDate>
    </SecurityValidateLogOnResult>
  </SecurityValidateLogOnResponse>
  </soap:Body>
</soap:Envelope>
```

The join conference service may be invoked when, for example, the nonparticipant 103 selects a join control or selects a conference from the conferencing schedule. A WebHostLogin() call may return a location for the virtual conference location. In an embodiment, the call may return a redirectUrl of a given client and host, which logs the client into a host. The notification application 123 may send the WebHostLogin() request, which contains the user's credentials, and then opens a web browser placing the user directly into the conference without the need to login again.

An exemplary XML response for the WebHostLogin() call may be configured as follows:

```
<?xml version=“1.0” encoding=“utf-8”?>
<soap:Envelope xmlns:xsi=“http://www.w3.org/2001/XMLSchema-
instance” xmlns:xsd=“http://www.w3.org/2001/XMLSchema”
xmlns:soap=“http://schemas.xmlsoap.org/soap/envelope/”>
  <soap:Header>
  <HeaderToken xmlns=“Conferencing”>
    <Token>string</Token>
  </HeaderToken>
  </soap:Header>
  <soap:Body>
  <WebHostLogin xmlns=“Conferencing”>
    <request>
    <ClientId>string</ClientId>
    <WebHost>None or VisionCast or VisionCastDemo or
  ReadyCast or ReadyCastDemo or ReadyCastProtect or
  AcrobatConnectPro or PgiAdobeConnect or ReadyCastMeeting
  or ReadyCastEvent or ConferencingHub</WebHost>
    <ConfId>int</ConfId>
    <DialInNumbers>
      <PhoneNumber>
      <Location>string</Location>
      <Number>string</Number>
      </PhoneNumber>
      <PhoneNumber>
      <Location>string</Location>
      <Number>string</Number>
      </PhoneNumber>
    </DialInNumbers>
    <Target>string</Target>
    </request>
  </WebHostLogin>
  </soap:Body>
</soap:Envelope>
```

An exemplary XML response for the WebHostLogin() call may be configured as follows:

```
<?xml version=“1.0” encoding=“utf-8”?>
<soap:Envelope xmlns:xsi=“http://www.w3.org/2001/XMLSchema-
instance” xmlns:xsd=“http://www.w3.org/2001/XMLSchema”
xmlns:soap=“http://schemas.xmlsoap.org/soap/envelope/”>
  <soap:Body>
  <WebHostLoginResponse xmlns=“Conferencing”>
    <WebHostLoginResult>
    <RedirectUrl>string</RedirectUrl>
    </WebHostLoginResult>
  </WebHostLoginResponse>
  </soap:Body>
</soap:Envelope>
```

One of ordinary skill in the art will appreciate that the notification application 123, the authentication application 125, and the cue configuration interface 200 (and any associated or other modules described herein) may be implemented in software, hardware, firmware, or a combination thereof. In one embodiment, the systems are implemented in software or firmware that is stored in a memory and that is executed by a suitable instruction execution system, such as, for example, an instruction system operable on a server computer or web server(s) 122. In software or firmware embodiments, the logic may be written in any suitable computer language. In hardware embodiments, the systems may be implemented with any or a combination of the following, or other, technologies, which are all well known in the art: discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

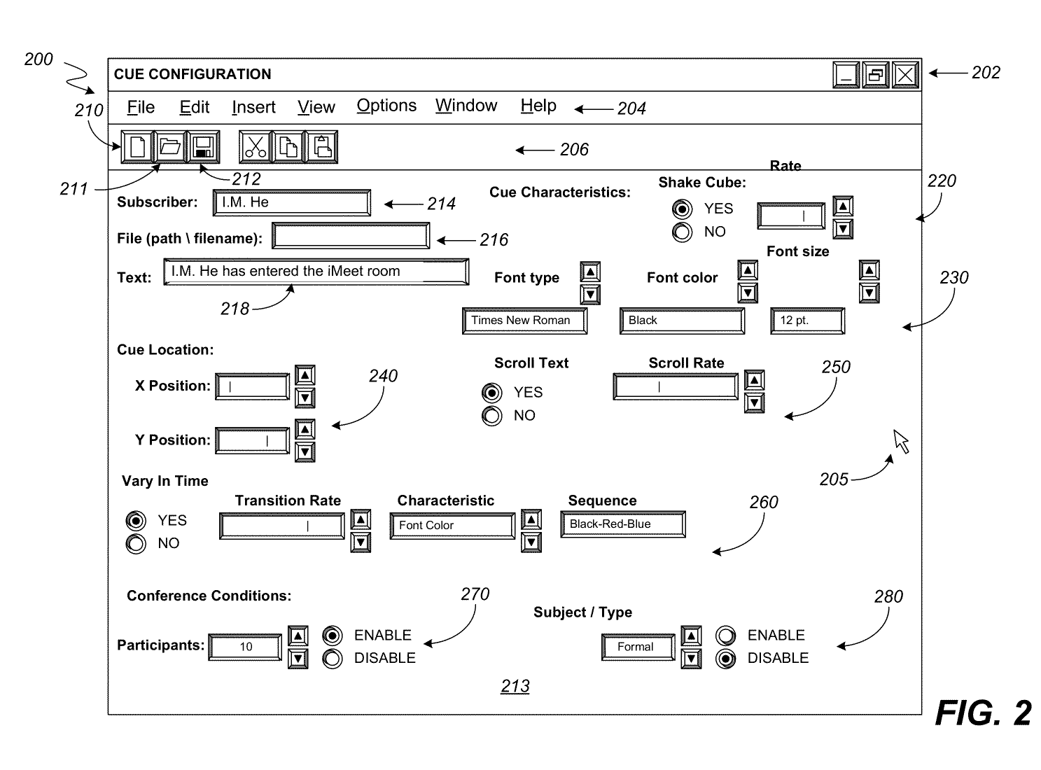

FIG. 2 illustrates an embodiment of the cue configuration interface 200 introduced in FIG. 1. A subscriber to the conference service supported by the conferencing system 106 accesses the cue configuration interface 200 to enter subscriber specific information, including information that identifies a subscriber specific cue. The cue information is published via the web server(s) 122 for execution by one or more components on client devices 102 coupled to the conference system 106. Specifically, the cue information is executed on the client device 102 for a designated period of time when the nonparticipant subscriber's client device 102n is connected to the audio conference 124 and/or the data conference via the conference user interface 126. The cue configuration interface 200 also includes fields for entering text, audio files, video files, image files and cue characteristics. Furthermore, the cue configuration interface 200 includes various mechanisms for enabling and disabling the cue upon the occurrence of specified conference conditions.

A moderator or other subscriber of a conferencing service supported by the conferencing system 106 may manually enter text messages, identify audio and/or video segments or files, or identify other symbols or icons and/or characteristics of the same via suitable user interface controls. In an embodiment, the cue configuration interface 200 may also provide a default list of general cue that can be adopted or used by multiple subscribers to the service.

The example cue configuration interface 200 includes a title bar 202, a drop-down menu bar 204, a tool bar 206 and a panel 213. The title bar 202 includes a label identifying the cue configuration interface and pushbutton controls for minimizing, maximizing and closing the interface as known in the art. The drop down menu bar 204 includes drop down menus related to file, edit, insert, view, options, window and help specific operations. The tool bar 206 includes various pushbutton controls for manipulating cue configuration files and information with in the files. Pushbutton 210 is associated with the operation of opening a new cue configuration file. Pushbutton 211 is associated with the operation of opening a previously created cue configuration file. Pushbutton 212 is associated with the operation of saving a cue configuration file. When one of the pushbuttons 210-212 is selected, a secondary information interface may be exposed to assist the user in completing the desired operation. In addition to the pushbuttons 210-212, the tool bar 206 includes additional pushbutton controls for cutting, copying and pasting information in the cue configuration interface 206.

The panel 213 is arranged to accept a subscriber name in input field 214, file information in input field 216 and text in input field 218. The operator of a computing device that is executing the cue configuration interface 200 selects one of the panel controls such as the input field 214, the input field 216 or the input field 218 by using a pointing input device to locate a cursor indicator 205 above the respective field. When selected in this manner, the panel 213 may provide an indication of the same by varying a characteristic of the border or frame surrounding the select input field. The remaining controls and associated input fields in the cue configuration panel 213 may be varied when an operator has identified a file and or file type in the input field 216. For example, when the operator has entered an audio format file in the input field 216 cue characteristics associated with location and visual characteristics have no meaning. These location and visual characteristic controls may be disabled or removed entirely from the cue configuration panel 213. When the controls are disabled, the controls may be presented in a light grey color or with some other indication that the control is not presently available. When the controls are removed entirely, they may be replaced by one or more controls commonly used to manipulate the playback of an audio file (e.g., volume, bass, treble, reverb, etc.).

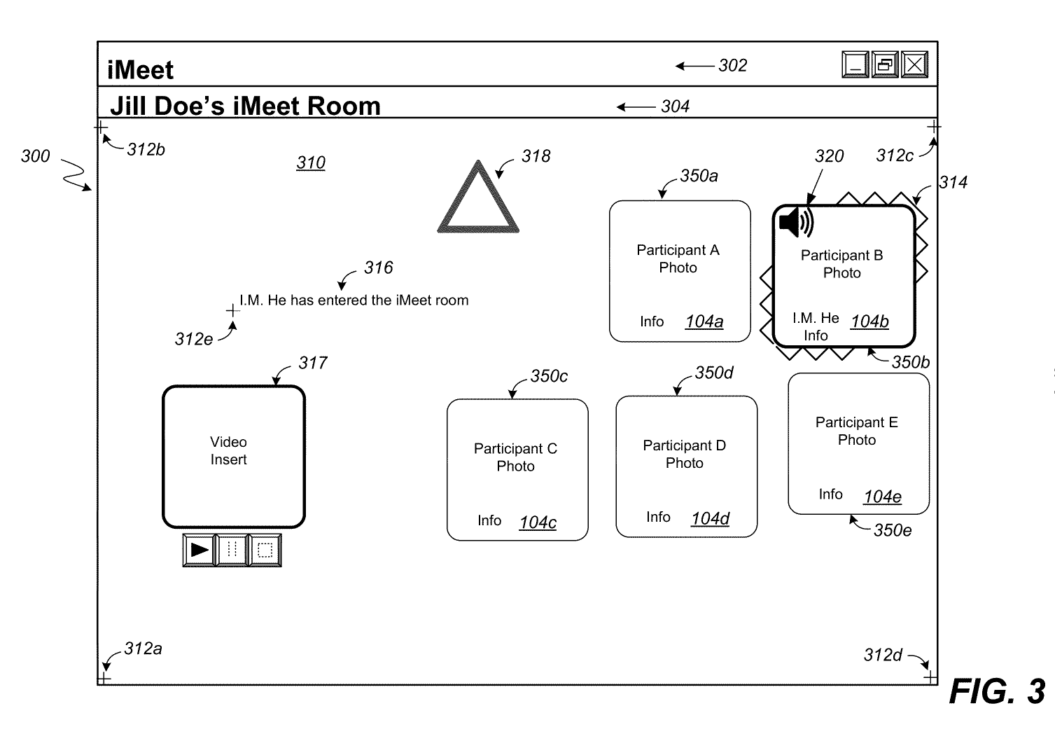

The cue configuration interface panel 213 is further arranged with a host of additional controls for adjusting various cue characteristics including one or more of location, size, color, font, movement and/or variation of one or more of these over time. A first set of controls 220 includes selection buttons to shake a cube element 350 (FIG. 3) in the virtual meeting room associated with the participant that joined the conference. The first set of controls further includes a rate indicator and associated controls to increase or decrease the rate. When enabled and configured, the first set of controls 220 instruct the conference user interface 126 to shake the cube associated with the participant for a designated period of time. The designated period of time can be set as a default time or alternatively can be configured using one or more controls (not shown) in the cue configuration interface 200.

A second set of controls 230 includes font type, color and size selectors for scrolling through a set of preconfigured options. A field associated with each of the font type, color and size selectors reflects a present selection of the respective font characteristic. Alternatively, an operator of the cue configuration interface 200 may manipulate the cursor element 205 over a desired field and enter the desired type, color, or size using a keyboard, keypad, touch sensitive screen, etc. to edit the information.

A third set of controls 240 includes an x-position field, a y-position field and respective up/down pushbutton controls to increase or decrease the associated x-position or y-position relative to an origin on the GUI 300. An operator of the cue configuration interface 200 adjusts these controls to instruct the conference user interface 126 as to the relative placement of the cue information when the cue information is rendered or otherwise presented on the client device 102. In the example embodiment, the x-position locator shows the desired cue location has an x-position that is relatively close to the origin with respect to the y-position. As indicated in FIG. 3, the origin is located in the left most and lower most corner of the GUI 300. However, the origin could be located in either of the remaining three corners of the GUI 300 or alternatively, the origin could be located in the center of the GUI 300 with relative positions from the origin defined by other coordinates or position location systems (e.g., a relative position can be defined using an angle and a distance.

A fourth set of controls 250 is used by an operator of the cue configuration interface 200 to controllably scroll a text message starting at the location identified by the third set of controls 240. The fourth set of controls 250 includes selection buttons that toggle or transition between enabling and disabling scrolling of the text message entered in field 218. The fourth set of controls 250 further includes a scroll rate field and respective up/down pushbutton controls to increase or decrease the scroll rate when the text is scrolled on the GUI 300.

A fifth set of controls 260 is used by an operator of the cue information configuration interface 200 to controllably vary the cue information over time. The fourth set of controls 260 includes selection buttons that toggle or transition between enabling and disabling variation of the cue information over time. The fifth set of controls 260 further includes a rate field and respective up/down pushbutton controls to increase or decrease the transition rate when the text in field 218 is presented on the GUI 300. The fifth set of controls 260 also includes a font color field and respective up/down pushbutton controls to select one of a set of preconfigured font colors available when presenting the text in field 218 on the GUI 300. Furthermore, the fifth set of controls 260 includes a color sequence field for identifying the order of multiple selected colors that will be used when transitioning the font color of the cue information over time in the GUI 300.

Sixth and seventh sets of controls are used by an operator of the cue information configuration interface 200 to set one or more conference conditions or thresholds. The existence of a condition in violation of the threshold or the absence of the condition entirely is used by the conference user interface 126 to controllably enable or disable the cue. The sixth set of controls 270 includes selection buttons that toggle or transition between enabling and disabling the cue in accordance with a threshold number of conference participants. The threshold number of conference participants is set by up/down pushbutton controls as reflected by the number presented in the participant field. When configured as indicated in FIG. 2, the conference user interface 126 will enable the cue when the number of participants in the conference exceeds 10. The seventh set of controls 280 includes selection buttons that toggle or transition between enabling and disabling the cue in accordance with a subject type. The subject type is configured by up/down pushbutton controls that scroll through a set of preconfigured subject types as reflected by the subject type presented in the subject type field. When configured as indicated in FIG. 2, the conference user interface 126 will disable the cue when the moderator of a conference has labeled the conference as a formal conference. Other conditions and thresholds can be configured using any number of criteria and suitable controls (not shown).

FIG. 3 illustrates an embodiment of the GUI 300 as presented on a client device 102. As described in more detail in U.S. patent application Ser. No. 12/771,979, the conference user interface 126 may forward or otherwise communicate, for display on a client device 102, a plurality of participant objects 350 (e.g., photograph or icon bearing information cubes associated with each of the participants 104). The participant objects 350 and additional content and/or functionality is presented in the GUI 300 to augment the audio conference 124. The GUI 300 communicated from the conferencing system 106 includes a title bar 302, a room identification bar 304, and a panel 310. The title bar 302 includes a label identifying the GUI 300 as an iMeet interface and further includes well recognized pushbutton controls for minimizing, maximizing and closing the interface as known in the art. The room identification bar 304 identifies the room as belonging to Jill Doe. The panel 310, in addition to revealing the participant objects 350, includes one or more indicators or cues that conference participant I.M He has joined the conference.

For example, a first indicator 314 shows that the participant cube 350b associated with I.M. He shakes or vibrates for a designated period once I.M He has entered Jill Doe's iMeet room. A text insert or second indicator 316 including the message, “I.M. He has entered the room” appears in the panel 310 at a start location 312e. As explained in association with the cue configuration interface 200, the location 312e of the text insert 316 is a relative position in a coordinate system where position 312a is an origin, position 312b is a minimum x-position and maximum y-position, position 312c is a maximum x-position maximum y-position and position 312d is a maximum x-position minimum y-position. An image/video insert 317 in panel 310 is presented when the participant (i.e., I.M. He) has configured a personal cue configuration file or cue information 152 that instructs the conference user interface 126 to play a video file or present an image file. An icon or sign 318 is representative of an additional indicator that may be presented in the panel 310 to announce or otherwise notify the present participants of the recent arrival of I.H He into the conference. Speaker element 320 may be enlarged, emboldened, vibrated or otherwise modified when I.M He has arranged for audio content to be played when he joins the conference. Once the audio or video segment has completed or the elapsed time allotted by a moderator or the cue configuration file has expired, the panel 310 may be modified to remove the text insert 316, the image/video insert 317, the sign or icon 318 and/or the speaker element 320 may be modified to show that I.M. He is present but not presently speaking.

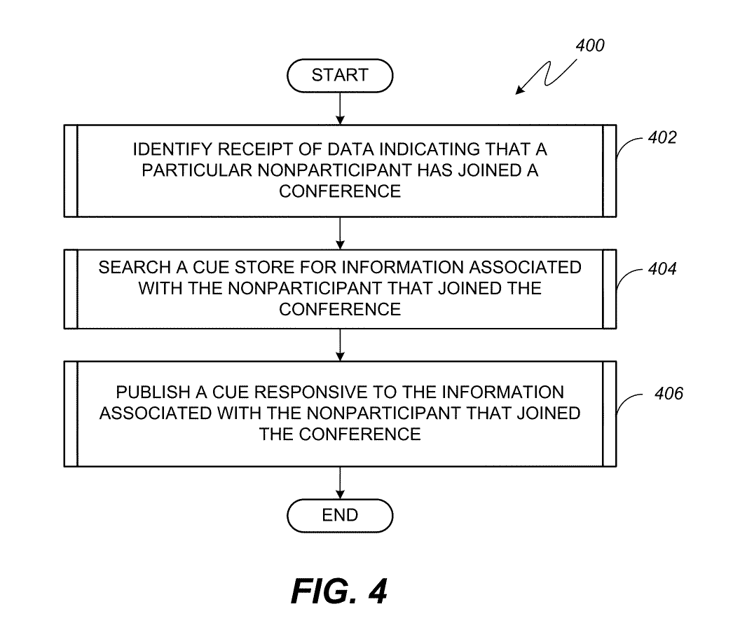

FIG. 4 includes a flow diagram that illustrates an embodiment of a method 400 for providing a cue when a nonparticipant 103 joins a data conference presented by the conference user interface 126 in conjunction with an audio conference 124. In block 402, a conferencing system 106 identifies the receipt of data indicating that a particular nonparticipant subscriber to a conferencing service has joined a conference. It should be understood that the data indicating that the subscriber and nonparticipant 103 has joined a conference could be communicated once a data connection has been established between the nonparticipant's client device 102 and the conferencing system 106. Alternatively, the data indicating that the subscriber and nonparticipant 103 has joined a conference could be communicated upon successful authentication of the participant's credentials. Whenever, the notification is communicated, the conferencing system 106 responds by searching a cue store 150 for cue information 152 stored by the nonparticipant 103 or cue information 154 stored by a moderator, as indicated in block 404. However generated, the cue information 152, 154 is associated with the nonparticipant 103 that wishes to join the conference. Once located, as shown in block 406, the conferencing system 106 publishes the cue information associated with the participant 104 that just joined the conference. As described above, the conferencing system 106 preferably uses a “push” methodology to communicate the cue information to one or more participants 104 of the conference.

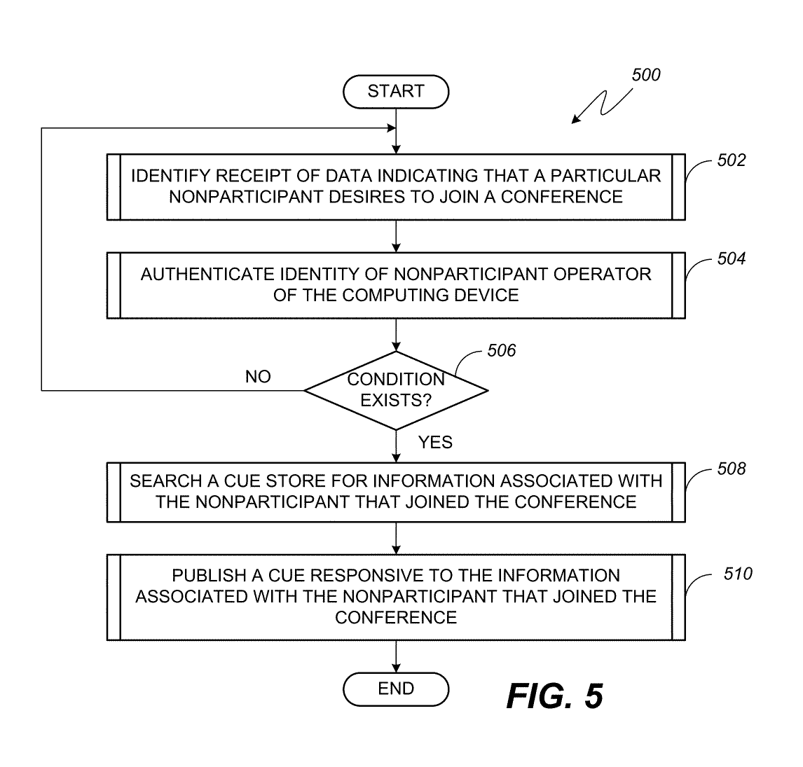

FIG. 5 includes a flow diagram illustrating an alternative embodiment of a method 500 for providing a cue when a nonparticipant 103 joins a data conference presented by the conference user interface 126 in conjunction with an audio conference 124. In block 502, a conferencing system 106 identifies the receipt of data indicating that a particular nonparticipant subscriber to a conferencing service has joined a conference. It should be understood that the data indicating that the subscriber and nonparticipant 103 has joined a conference could be communicated once a data connection has been established between the nonparticipant's client device 102 and the conferencing system 106. Thereafter, in block 504, the conferencing system 106 and more specifically an authentication application 125 verifies the identity of the nonparticipant 103 as a subscriber of a conferencing service supported by the conferencing system 106. Next, as shown in decision block 506, the notification application 123 and or the conference user interface 126 of the conferencing system 106 determines if a particular conference condition exists. When the conference condition does not exist, as indicated by the “NO” flow control arrow exiting the decision block 506, the method returns to block 502 to identify when a subsequent subscriber is attempting to join the conference. Otherwise, when the conference condition exists, as indicated by the “YES” flow control arrow exiting decision block 506, the method continues by searching a cue store 150 for cue information 152, 154 associated with the authenticated nonparticipant 103, as shown in block 508. Thereafter, as shown in block 510, the conferencing system 106 publishes a cue responsive to the cue information 152, 154 to one or more participants 104 of the conference.

It should be appreciated that one or more of the process or method descriptions associated with the flow charts or block diagrams above may represent modules, segments, logic or portions of code that include one or more executable instructions for implementing logical functions or steps in the process. It should be further appreciated that the logical functions may be implemented in software, hardware, firmware, or any combination thereof. In certain embodiments, the logical functions may be implemented in software or firmware that is stored in a volatile memory or non-volatile memory and that is executed by hardware (e.g., microcontroller) or any other processor(s) or suitable instruction execution system associated with the conference system. Furthermore, the logical functions may be embodied in any computer readable medium for use by or in connection with an instruction execution system, apparatus, or device, such as a computer-based system, processor-containing system, or other system associated with the conference system that can fetch the instructions from the instruction execution system, apparatus, or device and execute the instructions.

It should be noted that this disclosure has been presented with reference to one or more exemplary or described embodiments for the purpose of demonstrating the principles and concepts of the systems and methods for providing a cue when a participant joins a conference. The systems and methods are not limited to these embodiments. As will be understood by persons skilled in the art, in view of the description provided herein, many variations may be made to the embodiments described herein and all such variations are within the scope of the appended claims.

What is claimed is:

1. A method, comprising:
identifying, at a conference host computer, received data indicating that a particular nonparticipant has joined a conference;
searching, a cue store, for information associated with the particular nonparticipant; and
publishing, in a web server, a cue responsive to the information associated with the particular conference participant.

2. The method of claim 1, further comprising:
authenticating the identity of the nonparticipant as a subscriber to a conferencing service.

3. The method of claim 1, wherein searching the cue store for information associated with the nonparticipant includes information stored as directed by the nonparticipant in a previous communication with the conference host computer.

4. The method of claim 1, wherein publishing a cue responsive to the information associated with the nonparticipant includes manipulating a web server.

5. The method of claim 4, wherein manipulating the web server includes formatting information that exposes at least one of: text, an icon, an image, an audio segment, or a video segment to a conference participant.

6. The method of claim 4, wherein manipulating the web server includes modifying one or more characteristics of a select element communicated by the web server.

7. The method of claim 1, wherein the web server communicates formatted data to at least one of: a personal computer, a personal digital assistant, or a cellular phone.

8. The method of claim 1, further comprising:
verifying, at the conference host computer, at least one condition related to the conference before publishing the cue responsive to the information associated with the conference participant.

9. The method of claim 8, wherein the at least one condition is identified by the conference participant.

10. The method of claim 8, wherein the at least one condition is identified by a conference moderator.

11. The method of claim 1, further comprising:
verifying, at the conference host computer, at least one condition related to the conference does not exist before publishing the cue responsive to the information associated with the nonparticipant.

12. The method of claim 11, wherein the at least one condition is identified by the nonparticipant.

13. The method of claim 11, wherein the at least one condition is identified by a conference moderator.

14. A conferencing system, comprising:
client devices associated with respective display devices;
a conference host computer coupled to the client devices via one or more networks, the conference host computer operating a web server;
a cue store coupled to the conference host computer, the cue store including at least one cue element identified by a nonparticipant privileged to join the conference, the cue element including information designated for publication by the web server to one or more client devices connected to the conference.

15. The conferencing system of claim 14, wherein the conference host computer executes logic that presents a configuration interface to a user of the conferencing system via the web server, the configuration interface enabling the user to modify one or more characteristics of a select element communicated by the web server.

16. The conferencing system of claim 15, wherein the one or more characteristics include one or more of location, size, color, font, and the variation of one or more of these over time.

17. The conferencing system of claim 14, wherein the conference host computer executes logic that presents a configuration interface to a user of the conferencing system via the web server, the configuration interface enabling the user to communicate information containing one or more of text, an image, an audio segment, or a video segment to the cue store.

18. The conferencing system of claim 14, wherein the conference host computer executes logic that presents a configuration interface to a moderator of the conferencing system via the web server, the configuration interface enabling the moderator to communicate one or more conference conditions, the existence of which disable publication of the cue to conference participants.

19. The conferencing system of claim 14, wherein the conference host computer executes logic that presents a configuration interface to a user of the conferencing system via the web server, the configuration interface enabling the user to communicate one or more conference conditions, the existence of which disable publication of the cue to conference participants.

20. The conferencing system of claim 14, wherein the one or more client devices connected to the conference include at least one of: a personal computer, a personal digital assistant, or a cellular phone.
